(19) United States
(12) Patent Application Publication
(10) Pub. No.: US 2005/0258096 A1
(43) Pub. Date: Nov. 24, 2005

(54) Process for extracting biomedical devices

(75) Inventors: Ulick Stafford, Wexford (IE); Sanjay Rastogi, Rochester, NY (US); Mahendra Nandu, Pittsford, NY (US); William Appleton, Rochester, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/120,828

(22) Filed: May 3, 2005

Related U.S. Application Data
(60) Provisional application No. 60/573,495, filed on May 21, 2004.
(60) Provisional application No. 60/624,124, filed on Nov. 1, 2004.

(51) Int. Cl. B01D 11/00

(52) U.S. Cl. 210/634; 264/2.6; 264/1.1

(57) ABSTRACT

A process for treating biomedical devices, especially contact lenses, involves contacting polymeric devices containing extractables with a solvent that dissolves and removes the extractables from the devices. The devices are subjected to at least two treatments with solvent to remove extractables in the devices. One of the treatment steps involves solvent used as a final rinse for a prior batch of devices. The solvent may be circulated through a series of tanks, in which case the devices are first extracted in the downstream tanks, followed by extraction in the first tank containing fresh incoming solvent.

This application claims the benefit under 35 USC 119(e) of prior application Ser. No. 60/573,495, filed May 21, 2004, and Ser. No. 60/624,124, filed Nov. 1, 2004.

### FIELD OF THE INVENTION

The present invention relates to a process for removing extractables from polymeric biomedical devices, particularly ophthalmic devices including contact lenses, intraocular lenses and ophthalmic implants.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn, so generally, the articles are extracted to remove the residual articles. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded lens can be subjected to machining operations such as lathe cutting, buffing, and polishing, as well as packaging and sterilization procedures.

WO 03/082367 described an improved process for removing extractables from ophthalmic biomedical devices. Generally, the process comprises: contacting a batch of the devices containing extractables therein with a first volume of fresh solvent to remove some of the extractables from devices in the batch, and separating the batch of the devices from the first volume of solvent that now contains some of the extractables; followed by contacting the same batch of devices with a second volume of fresh solvent, to remove additional extractables from devices in this batch, and separating the batch of the devices from the second volume of solvent that now contains the additional extractables. Optionally, this batch may be contacted with additional volumes of fresh solvent to remove yet more extractables. Preferably, after completion of treatment of the batch of devices with solvent, the devices are contacted with water or an aqueous solution that replaces solvent remaining in the devices. The invention disclosed in WO 03/082367 ensures more uniform extraction efficiency among multiple batches of extracted lenses, as compared to prior extraction processes, as well as reducing the amount of solvent and/or reducing the total extraction time required to remove extractables from a given number of polymeric biomedical devices.

The present invention provides a process for removing extractables that offers improved process efficiencies and cost reductions over the process described in WO 03/082367.

### SUMMARY OF THE INVENTION

This invention provides an improved process for producing biomedical devices, particularly ophthalmic biomedical devices, and removing extractables in the devices.

According to certain embodiments, the process comprises: contacting a batch of the devices containing extractables therein with a first volume of solvent to remove some of the extractables from devices in the batch, and separating the batch of the devices from the first volume of solvent that now contains some of the extractables. This first volume of solvent, prior to contacting the batch of devices, includes extractables from a prior batch of devices. Subsequently, this same batch of devices is contacted with a second volume of fresh solvent, to remove additional extractables from devices in this batch, and the batch of the devices is separated from the second volume of solvent that now contains the additional extractables. Optionally, this batch of devices may be contacted with additional volumes of fresh solvent to remove yet more extractables. Preferably, after completion of treatment of the batch of devices with solvent, the devices are contacted with water or an aqueous solution that replaces solvent remaining in the devices.

According to other preferred embodiments, this invention provides a process for producing polymeric biomedical devices, comprising: circulating a solvent through tanks connected in series, wherein fresh solvent is received in a first tank in the series and the solvent is then circulated to at least one tank downstream of the first tank; and contacting a batch of the devices containing extractables therein with the solvent in the series of tanks to remove extractables from the devices, wherein the batch of the devices is contacted with the solvent in said at least one downstream tank and then contacted with the fresh solvent in said first tank. After contacting the batch of devices with the fresh solvent in the first tank, the devices may be contacted with water or an aqueous solution, whereby water replaces solvent remaining in the devices.

Preferably, the batch of the devices is immersed in the solvent, and the solvent comprises isopropanol. Preferred devices are ophthalmic biomedical devices, especially intraocular lenses or contact lenses.

According to certain other preferred embodiments, this invention provides a process comprising: circulating a solvent through tanks connected in series, wherein fresh solvent is received in a first tank in the series and the solvent is then circulated to at least one tank downstream of the first tank; and extracting polymeric biomedical devices in the series of tanks, wherein the devices are transported through the series of tanks in a direction opposite of circulation of solvent.

This invention still provides uniform extraction efficiency among multiple batches of extracted lenses, similar to the process described in WO 03/082367. Additionally, it has been found that the process of this invention results in further reductions in the amount of solvent required to remove extractables from a given number of polymeric biomedical devices, thereby offering cost reduction and improvements in process efficiencies.

### BRIEF DESCRIPTION OF THE DRAWING

FIG. 1 is a schematic representation of an apparatus and process for carrying out various preferred embodiments of this invention.

FIG. 2 is a schematic representation of an apparatus and process for carrying out various other preferred embodiments of this invention.

### DETAILED DESCRIPTION OF VARIOUS PREFERRED EMBODIMENTS

The present invention provides a method for removing extractables from biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to hydrogel contact lenses, a preferred embodiment of this invention, but the invention may be employed for extraction of other polymeric biomedical devices.

A hydrogel is a hydrated cross-linked polymeric system that contains water in an equilibrium state. Hydrogel lenses are generally formed by polymerizing a mixture of lens-forming monomers including at least one hydrophilic monomer. Hydrophilic lens-forming monomers include: unsaturated carboxylic acids such as methacrylic acid and acrylic acid; (meth)acrylic substituted alcohols or glycols such as 2-hydroxyethyl methacrylate, 2-hydroxyethyl acrylate, and glyceryl methacrylate; vinyl lactams such as N-vinyl-2-pyrrolidone; and acrylamides such as methacrylamide and N,N-dimethylacrylamide. Other hydrophilic monomers are well-known in the art.

The monomer mixture generally includes a crosslinking monomer, a crosslinking monomer being defined as a monomer having multiple polymerizable functionalities. One of the hydrophilic monomers may function as a crosslinking monomer or a separate crosslinking monomer may be employed. Representative crosslinking monomers include: divinylbenzene, allyl methacrylate, ethylene glycol dimethacrylate, tetraethyleneglycol dimethacrylate, polyethyleneglycol dimethacrylate, and vinyl carbonate derivatives of the glycol dimethacrylates.

One class of hydrogels is silicone hydrogels, wherein the lens-forming monomer mixture includes, in addition to a hydrophilic monomer, at least one silicone-containing monomer. When the silicone-containing monomer includes multiple polymerizable radicals, it may function as the crosslinking monomer. This invention is particularly suited for extraction of silicone hydrogel biomedical devices. Generally, unreacted silicone-containing monomers, and oligomers formed from these monomers, are hydrophobic and more difficult to extract from the polymeric device. Therefore, efficient extraction generally requires treatment with an organic solvent such as isopropanol.

One suitable class of silicone containing monomers include known bulky, monofunctional polysiloxanylalkyl monomers represented by Formula (I): 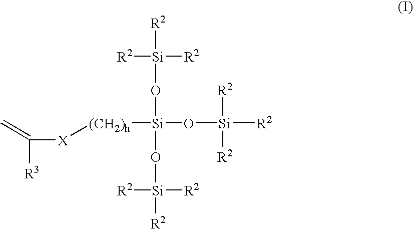
X denotes —COO—, —CONR⁴—, —OCOO—, or —OCONR⁴— where each where R⁴ is H or lower alkyl; R³ denotes hydrogen or methyl; h is 1 to 10; and each R² independently denotes a lower alkyl or halogenated alkyl radical, a phenyl radical or a radical of the formula
   —Si(R⁵)₃
   wherein each R⁵ is independently a lower alkyl radical or a phenyl radical. Such bulky monomers specifically include methacryloxypropyl tris(trimethylsiloxy)silane, pentamethyldisiloxanyl methylmethacrylate, tris(trimethylsiloxy) methacryloxy propylsilane, methyldi(trimethylsiloxy)methacryloxymethyl silane, 3-[tris(trimethylsiloxy)silyl] propyl vinyl carbamate, and 3-[tris(trimethylsiloxy)silyl] propyl vinyl carbonate.

Another suitable class is multifunctional ethylenically “end-capped” siloxane-containing monomers, especially difunctional monomers represented Formula (II): 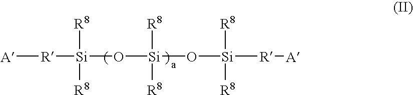
wherein:
each A′ is independently an activated unsaturated group;
each R′ is independently are an alkylene group having 1 to 10 carbon atoms wherein the carbon atoms may include ether, urethane or ureido linkages therebetween;
each R⁸ is independently selected from monovalent hydrocarbon radicals or halogen substituted monovalent hydrocarbon radicals having 1 to 18 carbon atoms which may include ether linkages therebetween, and
a is an integer equal to or greater than 1. Preferably, each R⁸ is independently selected from alkyl groups, phenyl groups and fluoro-substituted alkyl groups. It is further noted that at least one R⁸ may be a fluoro-substituted alkyl group such as that represented by the formula:
   —D′—(CF₂)_{S}—M′
   wherein:
D′ is an alkylene group having 1 to 10 carbon atoms wherein said carbon atoms may include ether linkages therebetween;
M′ is hydrogen, fluorine, or alkyl group but preferably hydrogen; and
s is an integer from 1 to 20, preferably 1 to 6.

With respect to A′, the term “activated” is used to describe unsaturated groups which include at least one substituent which facilitates free radical polymerization, preferably an ethylenically unsaturated radical. Although a wide variety of such groups may be used, preferably, A′ is an ester or amide of (meth)acrylic acid represented by the general formula: 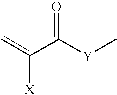
wherein X is preferably hydrogen or methyl, and Y is —O— or —NH—. Examples of other suitable activated unsaturated groups include vinyl carbonates, vinyl carbamates, fumarates, fumaramides, maleates, acrylonitryl, vinyl ether and styryl. Specific examples of monomers of Formula (II) include the following: 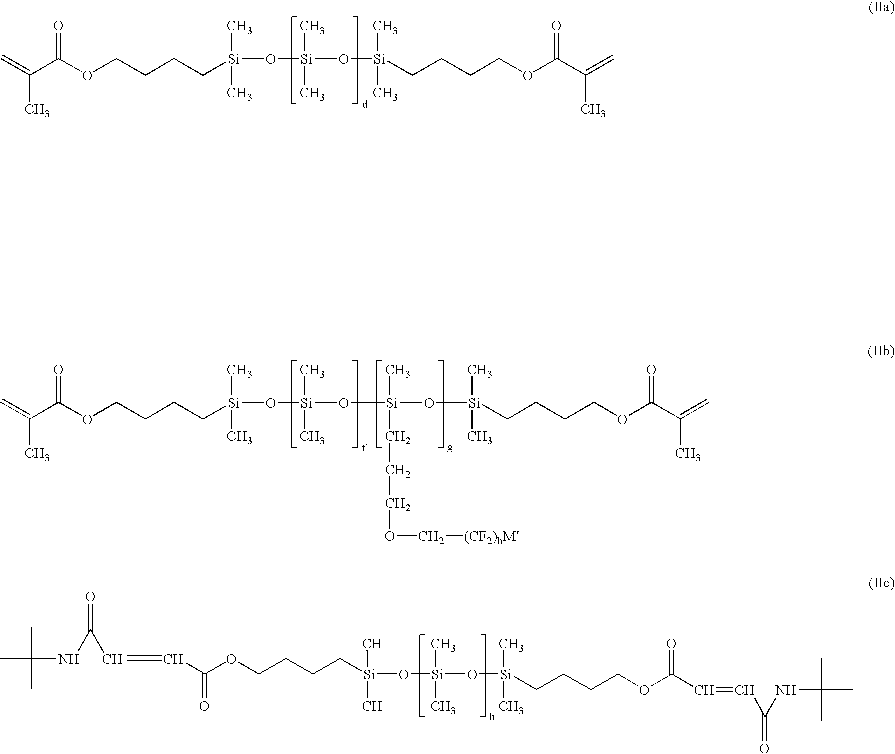
wherein:
d, f, g and h range from 0 to 250, preferably from 2 to 100; h is an integer from 1 to 20, preferably 1 to 6; and
M′ is hydrogen or fluorine.

A further suitable class of silicone-containing monomers includes monomers of the Formulae (IIIa) and (IIIb):
E′(*D*A*D*G)ₐ*D*A*D*E′; or (IIIa)
E′(*D*G*D*A)ₐ*D*G*D*E′; (IIIb)
wherein:
D denotes an alkyl diradical, an alkyl cycloalkyl diradical, a cycloalkyl diradical, an aryl diradical or an alkylaryl diradical having 6 to 30 carbon atoms;
G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;
* denotes a urethane or ureido linkage;
a is at least 1;
A denotes a divalent polymeric radical of the formula: 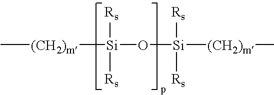
   wherein:
each R^{z} independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each E′ independently denotes a polymerizable unsaturated organic radical represented by the formula: 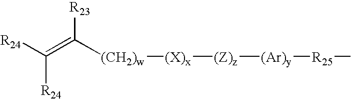
   wherein:

R₂₃ is hydrogen or methyl;
R₂₄ is hydrogen, an alkyl radical having 1 to 6 carbon atoms, or a —CO—Y—R₂₆ radical wherein Y is —O—, —S— or —NH—;
R₂₅ is a divalent alkylene radical having 1 to 10 carbon atoms; R₂₆ is a alkyl radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A specific urethane monomer is represented by the following: 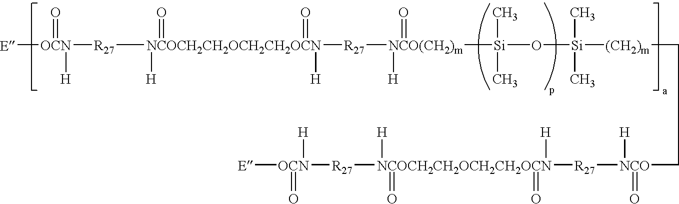
wherein m is at least 1 and is preferably 3 or 4, a is at least 1 and preferably is 1, p is a number which provides a moiety weight of 400 to 10,000 and is preferably at least 30, R₂₇ is a diradical of a diisocyanate after removal of the isocyanate group, such as the diradical of isophorone diisocyanate, and each E″ is a group represented by:

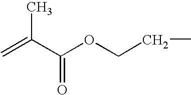

Other silicone-containing monomers include the silicone-containing monomers described in U.S. Pat. Nos. 5,034,461, 5,070,215, 5,260,000, 5,610,252 and 5,496,871, the disclosures of which are incorporated herein by reference. Other silicone-containing monomers are well-known in the art.

As mentioned, an organic diluent may be included in the initial monomeric mixture. As used herein, the term “organic diluent” encompasses organic compounds that are substantially unreactive with the components in the initial mixture, and are often used to minimize incompatibility of the monomeric components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

Removal of extractable components from polymeric contact lenses is typically carried out by contacting the lenses with an extraction solvent for a period of time sufficient to ensure substantially complete removal of the components. For example, according to one known method, a first batch of contact lenses may be immersed in a bath of isopropanol and held for several hours to effect removal of extractables such as unreacted monomers and oligomers from the lenses. This batch of lenses is removed from the bath, and a new batch of lenses is then immersed in the same bath. After several additional hours, this second batch is removed, and the process is repeated, until eventually the spent isopropanol in the bath is replaced with fresh isopropanol.

In the isopropanol bath, the concentration of extractables builds up as lens extraction proceeds and results in decreased efficiency in the removal of extractable material from later-treated lenses. Thus, even though all the lenses extracted by a bath of isopropanol may meet finished product specifications, there is a tendency for latter batches of lenses, extracted near the end of the solvent bath lifetime, to contain higher levels of residual extractables than batches treated earlier in its lifetime. Maintaining uniform extraction efficiency during the lifetime of the solvent bath is desirable and could obviously be achieved by lowering the number of lenses treated by a given quantity of solvent, but this would be undesirable from both an economic and an environmental standpoint as it would require higher volumes of solvent for a given number of lenses. Alternatively, extraction efficiency could be maintained by continuously replenishing the solvent; again, however, this approach may require higher volumes of solvent for a given number of lenses and result in generation of larger amounts of contaminated solvent requiring disposal.

The process described in WO 03/082367 ensures more uniform extraction efficiency among multiple batches of extracted lenses, while offering the opportunity to reduce the amount of solvent required to remove extractables from a given number of polymeric biomedical devices. The present invention provides even greater reduction in the amount of solvent required for a given number of devices, thus offering greater cost savings and improved efficiencies for larger scale commercial manufacturing. Specifically, the volume of solvent used can be reduced by up to 50 percent.

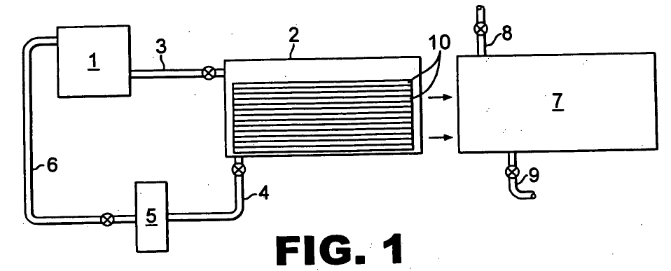

FIG. 1 illustrates schematically an apparatus and process for carrying out the invention according to various preferred embodiments. Fresh solvent, for example, isopropanol, is stored in vessel 1. Tank 2 initially contains a first batch of polymeric biomedical devices, for example, contact lenses. In the illustrated embodiment, this first batch of contact lenses is composed of several trays 10 stacked vertically, each tray 10 containing multiple contact lenses. This first batch of devices has already been contacted with a first volume of isopropanol. Then, a predetermined volume of fresh solvent from vessel 1 is pumped into tank 2 through line 3, this volume being sufficient to immerse the stack of trays 10. If desired, the solvent in tank 2 can be agitated to enhance its circulation in the tank and about the trays 10, for example, tank 2 may be equipped with a mechanical stirrer, or ultrasonic waves may be employed for the agitation. This batch of trays 10 is contacted with this volume of fresh solvent for a predetermined time. Trays 10 may then be transferred to tank 7. Tank 7 is filled with water or an aqueous solution, such as a buffered saline solution, through supply line 8, so as to immerse all trays 10 in the water or aqueous solution.

The solvent in tank 2, used for the final rinse step for the first batch of trays, remains in tank 2. Now, a second batch of devices will be processed. This second batch of lenses, also contained in stacked trays 10, is inserted in tank 2. Again, if desired, the solvent in tank 2 can be agitated to enhance its circulation in the tank and about the trays 10. As in conventional extraction processes, the solvent penetrates the devices and dissolves various extractables within the devices, such as unreacted monomers and oligomers. Then, the solvent in tank 2 is drained through line 4, whereby the extractables dissolved in the solvent are removed from tank 2 with the solvent.

This spent volume of solvent drained from tank 2 may be disposed of, or optionally, this volume may be subjected to a purification device 5 to remove the extractables therefrom, with purified solvent being returned to vessel 1 via line 6. It is understood that the term “fresh solvent” as used herein is inclusive of solvent that was previously used for extraction but purified to remove extractables therefrom. Representative purification devices include a packed bed or fluidized bed containing an adsorbing agent, such as activated carbon. Such methods of removing extractables from a solvent are disclosed in U.S. Pat. No. 6,423,820 (Ayyagari et al.), the disclosure of which is incorporated herein by reference.

Then, tank 2, still containing the same batch of trays 10, is refilled with a predetermined volume of fresh solvent from tank 1, and the lenses in this same batch of trays 10 is contacted with this second volume of solvent for a predetermined time, whereby additional extractables not removed by the first volume of solvent are dissolved in this fresh volume of solvent. Optionally, the batch of devices in trays 10 may be subjected to one or more additional treatments with fresh solvent if desired.

The solvent in tank 2 is not drained from tank 2, but is used for an initial rinse for the following third batch of lenses.

After the level of extractables in the devices in trays 10 has been reduced to a desired level, trays 10 may be transferred to tank 7. Tank 7 is filled with water or an aqueous solution, such as a buffered saline solution, through supply line 8, so as to immerse all trays 10 in the water or aqueous solution. The water or aqueous solution serves to rinse solvent from the devices, and thus, a water-miscible organic solvent is preferred so that it can easily be removed from the devices. Also, in the case of hydrogel copolymers, the water or aqueous solution is absorbed by the devices and replaces any organic solvent contained in the polymeric material. Stated differently, the water or aqueous solution flushes solvent from the devices. Tank 7 may optionally be provided with agitation, similar to tank 2, to facilitate circulation of the water or aqueous solution about the devices in trays 10. After a predetermined period of time, the water or aqueous solution is drained through line 9. Preferably, this batch of devices is subjected to at least one more treatment with water or aqueous solution in tank 7.

Subsequently, the trays 10 may be removed from tank 7 for additional processing. For example, in the case of contact lenses, the lenses can be packaged and sterilized.

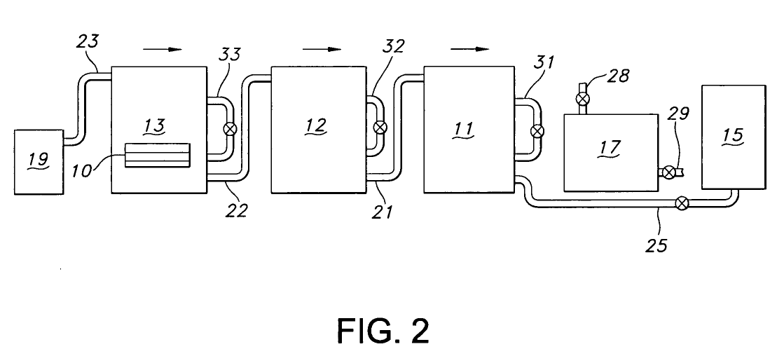

FIG. 2 illustrates schematically an apparatus and process for carrying out the invention according to various additional preferred embodiments. Fresh solvent, for example, isopropanol, is stored in vessel 15. The solvent is pumped through line 25 to tank 11. Solvent from tank 11 flows through line 21 to tank 12. Gravity feed may be used for line 21, or a pump may optionally be provided. Solvent from tank 12 flows through line 22 to tank 13. For the illustrated embodiment, tank 13 is the most downstream tank in the series of tanks, and solvent from tank 13 flows through line 23. Solvent from line 23 may be discarded, or, as illustrated in FIG. 1, this solvent may be received in purification device 19 to remove the extractables therefrom; purified solvent may then be returned to vessel 15.

As illustrated in FIG. 1, tank 13 contains a batch of polymeric biomedical devices, for example, contact lenses. In the illustrated embodiment, this batch of contact lenses is composed of several trays 10 stacked vertically, each tray containing multiple contact lenses. In tank 13, this tray 10 of lenses is immersed in the isopropanol. After a predetermined time, trays 10 are transferred to tank 12, where the contact lenses in the trays are again immersed in isopropanol. The solvent in tank 12 will have a higher purity (i.e., contain less extractibles from extraction of prior contact lenses) than solvent in tank 13. After a predetermined time, trays 10 are then transferred to tank 11, where the contact lenses in the trays are immersed in isopropanol. The solvent in tank 11 will have a higher purity level than solvent in tank 12. From tank 11, the trays 10 are transferred to vessel 17. Vessel 17 is filled with water or an aqueous solution, such as a buffered saline solution, so as to immerse all trays 10 in the water or aqueous solution. Accordingly, the arrows in FIG. 1 illustrate the transport of the batch of contact lenses in trays 10, this direction being opposite the direction of the circulation of solvent through the series of tanks.

The processing of batches of devices is preferably relatively continuous. Thus, immediately after trays 10 are transported from tank 13 to tank 12, a new set of trays may be placed in tank 13.

The solvent in tanks 11, 12 and 13 may be agitated to enhance its circulation in the tank and about the trays 10. As in conventional extraction processes, the solvent penetrates the devices and dissolves various extractables within the devices, such as unreacted monomers and oligomers, while the batches of devices are immersed in the solvent in the various extraction tanks.

The process provides uniform extraction efficiency among multiple batches of extracted lenses. The purity level of the solvent in each extraction tank remains relatively constant, such that each batch of lenses is subjected to solvent with similar purity in each of the tanks. As illustrated in FIG. 1, tank 11 may be provided with a circulation pump on line 31. Similarly, tank 12 and tank 13 may be provided with circulation line 32 and line 33, respectively. These circulation lines help to ensure that the isopropyl alcohol is circulated within the tank to improve the extraction efficiency and to maintain a consistent solvent concentration within each entire tank. It is noted, however, that in starting up this process, the first several batches of lenses will be exposed to solvent with less impurities. After the process reaches a steady-state, the purity level of the solvent in each tank will remain relatively constant.

Additionally, the process of this invention results in further reductions in the amount of solvent required to remove extractables from a given number of polymeric biomedical devices, thereby offering cost reduction and improvements in process efficiencies, as compared with the process in WO 03/082367.

Vessel 17 is filled with water or an aqueous solution, such as a buffered saline solution, through supply line 28, so as to immerse all trays in the water or aqueous solution. The water or aqueous solution serves to rinse solvent from the devices, and thus, a water-miscible organic solvent is preferred so that it can easily be removed from the devices. Also, in the case of hydrogel copolymers, the water or aqueous solution is absorbed by the devices and replaces any organic solvent contained in the polymeric material. Stated differently, the water or aqueous solution flushes solvent from the devices. Vessel 17 may optionally be provided with agitation, similar to the extraction tanks, to facilitate circulation of the water or aqueous solution about the devices in trays 10. After a predetermined period of time, the water or aqueous solution is drained through line 29. Preferably, this batch of devices is subjected to at least one more treatment with water or aqueous solution in vessel 17.

Subsequently, the trays 10 may be removed from vessel 17 for additional processing. For example, in the case of contact lenses, the lenses can be packaged and sterilized.

Illustrative process conditions are as follows. First, each tank may be sized to hold 100 contract lenses, with a flow rate of isopropanol of 0.33 liter/hour, and a holding time in each tank of 55 minutes. Second, each tank may be sized to hold 300 contract lenses, with a flow rate of isopropanol of 1 liter/hour, and a holding time in each tank of 55 minutes. Third, each tank may be sized to hold 750 contract lenses, with a flow rate of isopropanol of 2.5 liters/hour, and a holding time in each tank of 55 minutes. Of course, a person skilled in the art, given the present description, can readily optimize the process conditions for biomedical devices requiring various extraction levels.

Preferably, the tanks and solvent therein are maintained at room temperature. However, if desired, the solvent may be heated.

As used herein, the term “fresh solvent” is inclusive of solvent that was previously used for extraction but purified to remove extractables therefrom. Representative purification devices include a packed bed or fluidized bed containing an adsorbing agent, such as activated carbon. Such methods of removing extractables from a solvent are disclosed in U.S. Pat. No. 6,423,820 (Ayyagari et al.), the disclosure of which is incorporated herein by reference.

Various trays for holding the devices are known in the art. Generally, the trays should retain the lenses or devices so they are not misplaced during extraction, and the trays should permit good circulation of solvent about the lenses or devices. Representative trays are described in U.S. Pat. No. 6,581,761 (Stafford et al.), and WO 03/082367 (Indra et al., U.S. application Ser. No. 10/392,741, filed Mar. 19, 2003), the disclosures of which are incorporated herein by reference.

Having thus described the preferred embodiment of the invention, those skilled in the art will appreciate that various modifications, additions, and changes may be made thereto without departing from the spirit and scope of the invention, as set forth in the following claims.

1. A process for producing polymeric biomedical devices, comprising:
contacting a batch of the devices containing extractables therein with a first volume of solvent to remove some extractables from said batch of the devices, wherein the first volume of solvent, prior to contacting the batch of devices, includes extractables from a prior batch of devices;
separating the batch of the devices from the first volume of solvent that contains said some extractables from said batch of the devices;
contacting said batch of the devices with a second volume of solvent having a higher purity than said first volume, to remove additional extractables from said batch of the devices; and
separating the batch of the devices from the second volume of solvent that contains said additional extractables.

2. The process of claim 1, wherein the batch of the devices is immersed in the first and second volumes of solvent.

3. The process of claim 1, wherein the solvent comprises isopropanol.

4. The process of claim 1, wherein said devices are ophthalmic biomedical devices.

5. The process of claim 4, wherein said devices are ophthalmic lenses.

6. The process of claim 5, wherein said devices are contact lenses.

7. The process of claim 6, wherein the contact lenses are composed of a silicone hydrogel copolymer.

8. The process of claim 1, wherein the devices are composed of a silicone hydrogel copolymer.

9. The process of claim 1, optionally comprising contacting said batch of the devices with a third volume of fresh solvent to remove additional extractables from said batch of the devices.

10. The process of claim 1, further comprising, following solvent extraction, contacting said batch of the devices with water or an aqueous solution, whereby water replaces solvent remaining in the devices.

11. The process of claim 10, wherein the batch of the devices are contacted with fresh water or fresh aqueous solution several times.

12. The process of claim 1, wherein the first volume of solvent separated from the batch of the devices is purified to remove extractables therefrom.

13. The process of claim 1, wherein the second volume of solvent separated from the batch of the devices is used, without purification, to remove extractables from a subsequent batch of devices.

14. The process of claim 1, comprising:
circulating a solvent through tanks connected in series, wherein fresh solvent is received in a first tank in the series and the solvent is then circulated to at least one tank downstream of the first tank; and
contacting a batch of the devices containing extractables therein with the solvent in the series of tanks to remove extractables from the devices, wherein the batch of the devices is contacted with the solvent in said at least one downstream tank and then contacted with the solvent in said first tank.

15. The process of claim 14, comprising:
circulating a solvent through tanks connected in series, wherein fresh solvent is received in a first tank in the series and the solvent is then circulated to a second tank and a third tank downstream of the first tank; and
contacting a batch of the devices containing extractables therein with the solvent in the series of tanks to remove extractables from the devices, wherein the batch of the devices is contacted with the solvent in said third tank, then with the solvent in said second tank, and then with the solvent in said first tank.

16. A process comprising:
circulating a solvent through tanks connected in series, wherein fresh solvent is received in a first tank in the series and the solvent is then circulated to at least one tank downstream of the first tank; and
extracting polymeric biomedical devices in the series of tanks, wherein the devices are transported through the series of tanks in a direction opposite of circulation of solvent.

17. The process of claim 16, wherein fresh solvent is received in a first tank in the series and the solvent is then circulated to a second tank and a third tank downstream of the first tank; and the devices are extracted sequentially in the third, second and first tanks.

18. A process for producing polymeric biomedical devices, comprising:
contacting a batch of the devices containing extractables therein with a first volume of solvent to remove some extractables from said batch of the devices, wherein the first volume of solvent, prior to contacting the batch of devices, includes extractables from a prior batch of devices;
separating the batch of the devices from the first volume of solvent that contains said some extractables from said batch of the devices;
contacting said batch of the devices with a second volume of fresh solvent, to remove additional extractables from said batch of the devices; and
separating the batch of the devices from the second volume of solvent that contains said additional extractables.
